(19) United States
(12) Patent Application Publication
(10) Pub. No.: US 2005/0007346 A1
(43) Pub. Date: Jan. 13, 2005

(54) Optical conduit for channeling light onto a surface

(76) Inventors: Guolin Ma, Milpitas, CA (US); Jason Hartlove, Los Altos, CA (US); Boon-Kheng Lee, Kedah (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/618,317

(22) Filed: Jul. 11, 2003

(51) Int. Cl. G09G 5/08

(52) U.S. Cl. 345/166

(57) ABSTRACT

An optical conduit in an optical mouse is used to channel light from a light source onto a surface for illumination. Light from the light source is totally and internally reflected within the optical conduit towards the surface. To improve the efficiency of light transmission, the light source is glued to the exterior of the optical conduit, or embedded within the optical conduit itself. A reflector cup can be used to surround the light source so as to redirect light from the light source towards the output end of the optical conduit. The optical conduit can have curved surfaces that fit parabolic or hyperbolic equations, or other equations of second-order or higher.

### FIELD OF THE INVENTION

The invention is directed towards optical devices, and more specifically, towards optical conduits that efficiently capture light from a light source and redirect it onto a surface for illumination.

### BACKGROUND OF THE INVENTION

An optical mouse operates by scanning an illuminated surface with an optical sensor and acquiring a series of images of the surface. The optical mouse then determines its own position relative to the surface by comparing the differences between the images. The light source used for illuminating the surface is typically a light-emitting diode (LED). Since the light emitted by an LED is dispersed over a wide angle, an optical conduit is used to channel and focus the light from the LED onto the surface.

FIG. 1A is an abstract sketch of the components in a prior art optical mouse 100. A portion of the light emitted from an LED 103 is transmitted into an optical conduit 101. The light travels along the optical conduit 101 by total internal reflection until it exits the optical conduit 101 and strikes a surface 105. The light reflects off of the surface 105, through a lens 107, and onto an image sensor 109 in the optical mouse 100.

FIG. 1B shows a perspective view of the prior art optical conduit 101 and LED 103. The optical conduit 101 is not very efficient at illuminating the surface 105 for several reasons. First, the LED 103 and optical conduit 101 are two separate components. Much of the light emitted by the LED 103 disperses in the distance between the LED and conduit, thus decreasing the amount of light that is captured by the optical conduit 101. Furthermore, the optical conduit 101 has flat interior side surfaces. As a result, some of the light that is transmitted into the optical conduit 101 manages to escape before it hits the surface 105, because the light hits the interior surfaces of the optical conduit 101 at the wrong angle for total internal reflection. Lastly, light rays emitting from the backside of the LED 103 are dispersed and cannot be captured by the optical conduit 101. The maximum efficiency of the prior art optical conduit 101 has been estimated to be around 10%, where efficiency is defined to be the percentage of light power that is transmitted by the optical conduit 101 from the light source to the surface.

Since the efficiency of the prior art optical conduit 101 is poor, the power of the LED 103 needs to be increased to adequately illuminate the surface 105. Increasing the LED power is not a problem when the optical mouse is attached by a cord to a desktop computer system. However, power consumption is a big concern in applications such as laptops or battery-powered cordless mice. Therefore, a more efficient optical conduit is needed.

### SUMMARY OF THE INVENTION

In a preferred embodiment of the present invention, an optical conduit for channeling light from a light source onto a surface is created by combining the optical conduit with the light source to create a single component. The optical conduit has an input end for light input, and an output end where the light exits the optical conduit to fall onto the surface. When the optical conduit is made of a moldable material, the light source can be embedded into the input end of the optical conduit itself. Alternatively, the light source can be glued to the exterior of the input end of the optical conduit.

In an alternate embodiment, the light source within the optical conduit is surrounded by a reflective cup. The reflective cup captures light rays that would otherwise escape the optical conduit because they were emitted in the wrong direction, and redirects them towards the output end of the optical conduit.

In an alternate embodiment, the optical conduit is in the shape of a paraboloid. The curved interior surface of the paraboloid is more efficient at collecting and concentrating light than a flat surface.

Further features and advantages of the present invention, as well as the structure and operation of preferred embodiments of the present invention, are described in detail below with reference to the accompanying exemplary drawings. In the drawings, like reference numbers indicate identical or functionally similar elements.

### BRIEF DESCRIPTION OF THE DRAWINGS

FIG. 1A is an abstract sketch of the components in a prior art optical mouse.

FIG. 1B shows a perspective view of the prior art optical conduit and LED.

FIG. 2A is a perspective view of an optical conduit.

FIG. 2B shows a reflector cup in perspective view surrounding the light source.

FIG. 2C shows a side view of the optical conduit, in an embodiment where the light source is now surrounded by a reflector cup.

FIG. 3 shows a perspective view in which the optical conduit has the shape of a paraboloid.

FIG. 4 shows an alternate embodiment in which the optical conduit has an elbow to bend the light output towards a desired surface.

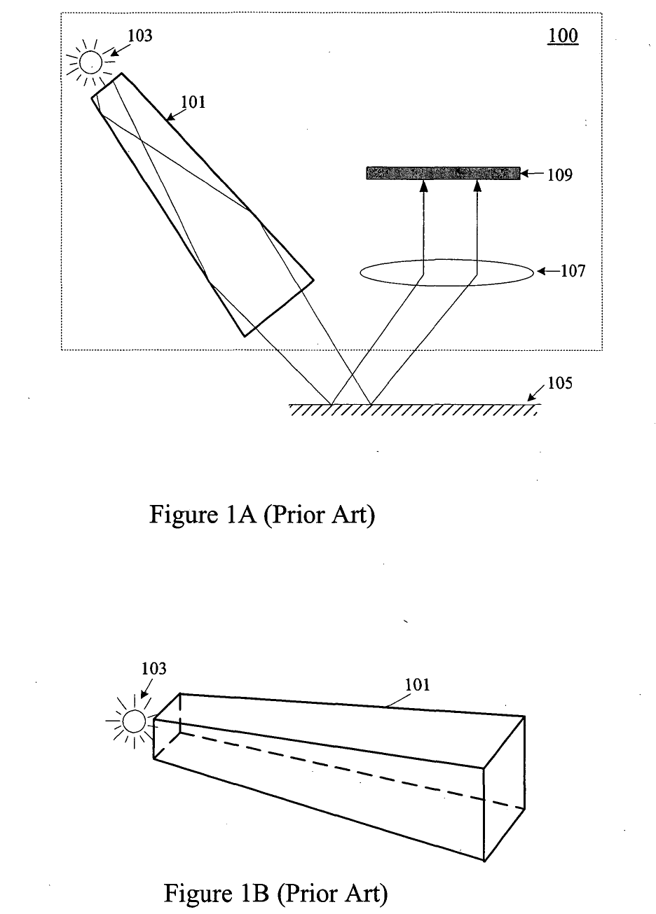

### DETAILED DESCRIPTION

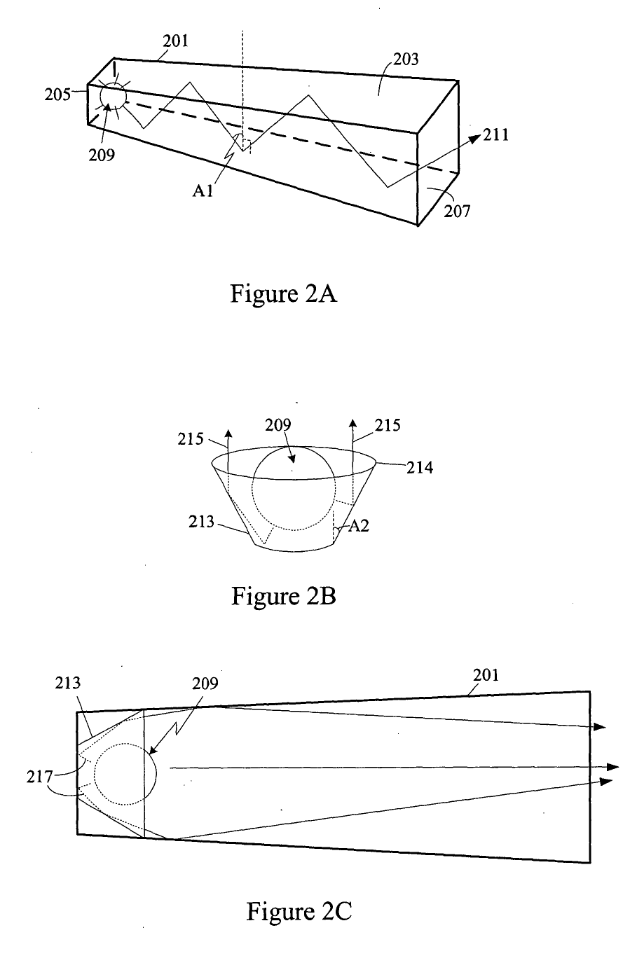

FIG. 2A is a perspective view of an optical conduit 201 made in accordance with the teachings of the present invention. Optical conduit 201 has 4 sidewalls 203 with flat interior surfaces, an input end 205 for light input, and an output end 207 for light output. The optical conduit 201 can have more than 4 sidewalls. The output end 207 is generally larger than the input end 205. The output end 207 is shown as a flat surface parallel to the input end 205, but can also be angled to the rest of the body to change the angle of the ray exiting the optical conduit 201. The end surface can also be concave or convex for converging and diverging purposes.

The refractive index n of the optical conduit 201 is higher than that of the surrounding medium, which is typically air. Possible choices of material for the optical conduit 201 include acrylic, polycarbonate, optical grade plastics, or any other material optically transmissive to light in the visible and infrared spectrum range.

A light source 209, such as an LED, is embedded directly in the optical conduit 201. More light is captured in this arrangement than in the prior art, since light rays emitted by the light source 209 now originate from within the optical conduit 201 itself. The optical conduit 201 is preferably made of a moldable material, so that the light source 209 may be inserted into the optical conduit before the material cures and sets. Any light rays, such as exemplary light ray 211, that hit the interior surface at an angle A1 greater than the critical angle θ_{c} will be totally internally reflected. θ_{c} is determined by Snell's law: sin θ_{c}>nₛ/n ; where nₛ is the index of refraction for the surrounding medium, and n is the index of refraction for the conduit itself.

The light 211 travels along the optical conduit 201, reflecting off the flat interior surface of the sidewalls 203 towards the output end 207. The light 211 hits each wall at an angle greater than the critical angle and is reflected back into the optical conduit 201. The light 211 finally exits through the output end 207 to strike the surface to be illuminated. Since the light source 209 and the optical conduit 201 are now one piece, there is no loss of light due to separation between the light source 209 and the optical conduit 201. In an alternate embodiment (not shown), the light source 209 is glued directly to the exterior surface of the optical conduit 201 at its input end 205, using optically transmissive glue.

Since the light source 209 radiates light in all directions, many of its light rays are radiated in a direction away from the output end 207 such that the light rays escape the optical conduit 201 without being totally internally reflected towards the output end 207. By surrounding the light source 209 with a reflective surface to capture and redirect such light rays, the efficiency of the optical conduit 201 can be further increased.

FIG. 2B shows a reflector cup 213 in perspective view surrounding the light source 209. The reflector cup 213 encloses the light source 209 on all sides except at the opening 214 of the reflector cup 213. It is made of or plated with a reflective material, such as gold, silver, copper, platinum, etc. The sides of the reflector cup 213 are positioned at an acute angle A2. An angle A2 of 45 degrees is sufficient to deflect the light rays, although other acute angles are also suitable. Any light rays 215 from the light source that hit the reflector cup 213 are redirected towards the opening 214 of the reflector cup 213.

FIG. 2C shows a side view of the optical conduit 201, in an embodiment where the light source 209 is now surrounded by a reflector cup 213. The reflector cup 213 is embedded within the optical conduit, and positioned such that the opening 214 faces the output end 307. The reflector cup 213 redirects light rays 217 that hit the reflector cup 213 towards the output end 207 of the optical conduit 201. The reflector cup 213 allows most of the light emitted by the light source 209 to be transmitted towards the output end 207 and increases the efficiency of the optical conduit 201. The reflector cup 213 may be embedded into the optical conduit 201 at the same time as the light source 209.

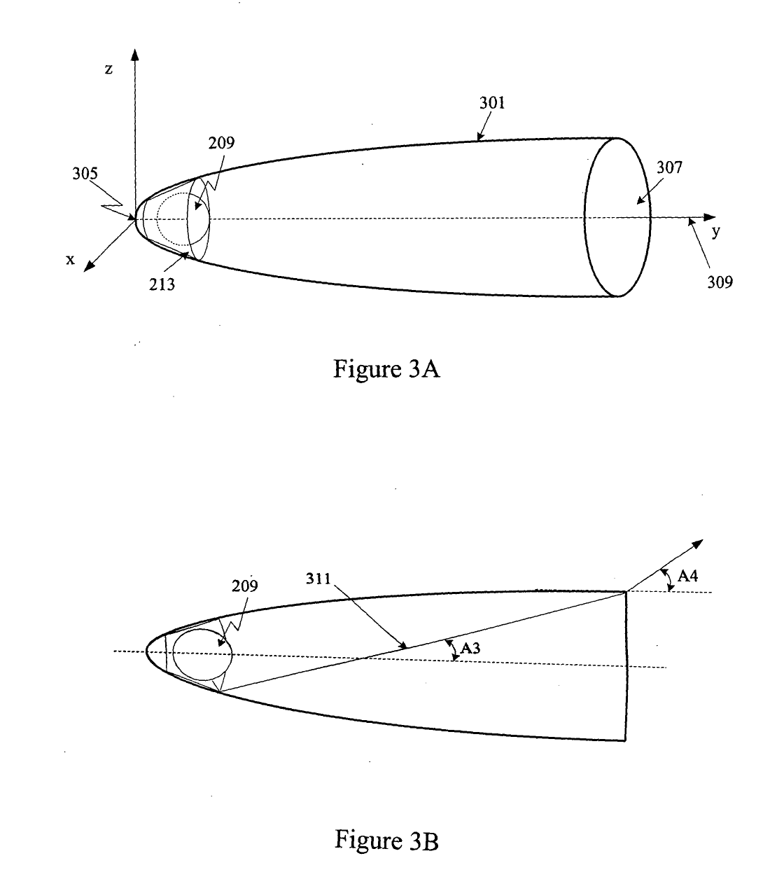

FIG. 3A shows a perspective view of another embodiment of the present invention, in which the optical conduit is a paraboloid 301. A paraboloid is a solid of revolution, in which a parabola according to the equation y=Ax² (where A is a constant) is revolved around its central axis of symmetry 309 to create a 3-dimensional solid. The paraboloid 301 is more efficient than the optical conduit 201, since curved surfaces are more efficient at collecting and concentrating light rays than flat surfaces.

The paraboloid 301 has an input end 305 for light input, and an output end 307 for light output. A light source 209 surrounded by a reflector cup 213 is embedded into the input end 305, such that the opening of the reflector cup 213 is facing the output end 307. In an actual working embodiment, a paraboloid having an embedded light source surrounded by a reflector cup achieved efficiencies around 16%, which is a 60% increase over the old efficiency.

FIG. 3B illustrates a cross-sectional slice of the optical conduit that passes through its center axis of symmetry 309, and shows the pertinent angles that need to be calculated to ensure total internal reflection of the light rays originating from the light source. A light ray 311 traveling from the light source 209 to a point on the surface of the paraboloid creates an angle A3 with the center axis of symmetry 309 and another angle A4 with the surface of the paraboloid 301 when it exits the paraboloid. When the surrounding medium of the paraboloid 301 is air, the angles A3 and A4 at which total internal reflection will occur must meet the following conditions:
sin A3≦1−(2/n²), (Equation 1)
or
sin A4≦n−(2/n), (Equation 2)
where n is the index of refraction for the paraboloid 301.

In general, a curved surface is more efficient at collecting and concentrating light rays than a flat surface. Therefore, an optical conduit with a curved surface will be more efficient than a flat-sided optical conduit. Other suitable surfaces have curvatures fitting parabolic equations, hyperbolic equations, or any equations of second-order or higher, as long as the surface curvatures still satisfy equation 1 or 2. For example, an optical conduit in the shape of a hyperboloid (a solid of revolution formed by rotating a hyperbola around its axis of symmetry) will have improved performance over a flat-sided optical conduit.

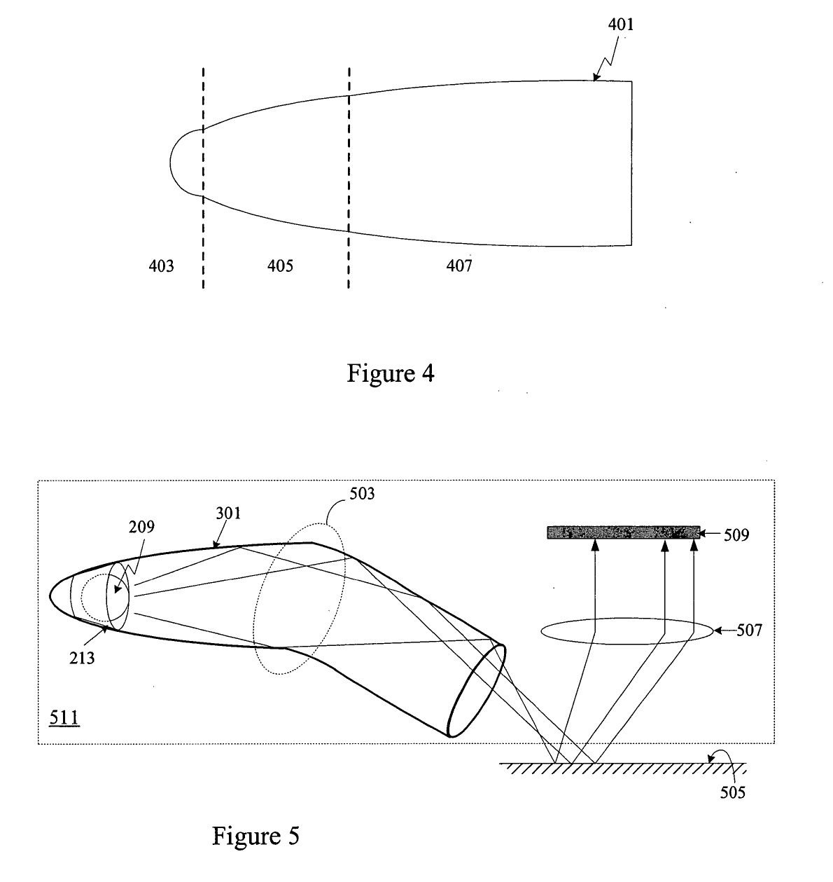

A combination of different curvatures may also be used. For example, in FIG. 4, an optical conduit 401 having 3 sections of differing curvature is shown in side view. In the first section 403, the optical conduit has a spherical surface. In the second section 405, the surface curvature is parabolic. And in the third section 407, the surface curvature is hyperbolic. In this embodiment, when the surface curvature follows equation 1 or 2, the conditions for total internal reflection will be met.

To facilitate the illumination of a surface, a gradual bend may be introduced between the input and output ends of the optical conduit, after the proper surface curvature for the optical conduit has been determined by equation 1 or 2. FIG. 5 shows an alternate embodiment in which the paraboloid optical conduit 301 has a gradual bend 503 to bend the light output towards a desired surface 505. A lens 507 above the surface focuses the rays bouncing off the surface 505 onto an optical sensor 509. The optical conduit 301, lens 507, and optical sensor 509 are all disposed within the housing of an optical mouse 511. Some loss of light is to be expected when the gradual bend 503 is added, since the curvature no longer exactly meets the constraints of equation 1 or 2 for total internal reflection.

Although the present invention has been described in detail with reference to particular preferred embodiments, persons possessing ordinary skill in the art to which this invention pertains will appreciate that various modifications and enhancements may be made without departing from the spirit and scope of the claims that follow.

1. An optical conduit for illuminating a surface, comprising:
a body formed from optically transmissive material, having:
an input end for light input;
an output end for light output;
a curved surface that totally and internally reflects light from the input end towards the output end; and
a light source embedded at the input end of the body, such that light is channeled from the input end through the body and emitted out the output end.

2. The optical conduit as in claim 1, further comprising:
a reflector cup surrounding the light source, for redirecting light from the light source towards the output end of the body.

3. The optical conduit as in claim 2, wherein the curved surface of the body is a paraboloid.

4. The optical conduit as in claim 2, wherein the body is made up of sections of curved surfaces fitting different equations.

5. The optical conduit as in claim 2, wherein the light source is a light-emitting diode.

6. The optical conduit as in claim 2, wherein the body has a gradual bend so that the output end is at an angle to the input end.

7. The optical conduit as in claim 2, wherein the optically transmissive material is chosen from acrylic, polycarbonate, and optical grade plastic.

8. An optical mouse, comprising
a housing;
an image sensor within the housing for capturing images of a surface;
a light source within the housing;
an optical conduit made from optically transmissive material, channeling light from the light source onto the surface, having:
a input end for light input;
a output end for light output; and
a curved interior surface that totally and internally reflects light from the input end towards the output end; and
a lens to focus light reflecting off of the surface onto the image sensor.

9. The optical mouse of claim 8, wherein the light source is glued to the exterior of the input end of the optical conduit.

10. The optical mouse of claim 8, wherein the light source is embedded within the input end of the optical conduit.

11. The optical mouse as in claim 10, further comprising:
a reflector cup surrounding the light source, for redirecting light from the light source towards the output end of the optical conduit.

12. The optical mouse as in claim 11, wherein the curved surface of the body is a paraboloid.

13. An optical mouse, comprising
a housing;
an image sensor within the housing for capturing images of a surface;
an optical conduit within the housing made from optically transmissive material, the optical conduit having:
a input end for light input;
a output end for light output; and
an interior surface that totally and internally reflects light from the input end towards the output end;
a light source embedded within the input end of the optical conduit; and
a lens within the housing to focus light reflecting off of the surface onto the image sensor.

14. The optical mouse of claim 13, further comprising:
a reflector cup surrounding the light source, for redirecting light from the light source towards the output end of the optical conduit.
